(19) United States
(12) Patent Application Publication
(10) Pub. No.: US 2021/0046969 A1
(43) Pub. Date: Feb. 18, 2021

(54) STEERABLE SLEDDING SYSTEM

(71) Applicant: Zach J. Lund, Holladay, UT (US)

(72) Inventor: Zach J. Lund, Holladay, UT (US)

(21) Appl. No.: 16/542,618

(22) Filed: Aug. 16, 2019

(51) Int. Cl. B62B 13/08; B62B 17/06

(52) U.S. Cl. CPC B62B 13/08; B62B 2501/065; B62B 17/063

(57) ABSTRACT

Embodiments described herein are related to a steerable sledding system. The steerable sledding system may include a steering structure designed to enable a user to steer the steerable sledding system. The steering structure may include a first substantially horizontal portion that forms a first rear edge of the steering structure and sidewalls. The first substantially horizontal portion may form a first opening proximate the first rear edge. The steerable sledding system may further include a platform structure designed to support the user of the steerable sledding system. The platform structure may form a second opening proximate a second front edge of the platform structure. The steerable sledding system may further include a pivoting device designed to connect the steering structure and the platform structure via the first opening and the second opening to enable the steering structure and the platform structure to pivot relative to each other.

### BACKGROUND

A sled is a vehicle that slides across a surface (e.g., ice, snow, sand, etc.). Sleds may have a smooth flat surface on the bottom to reduce friction and help the sled slide smoothly. Some sleds have a top surface capable of carrying riders, passengers, or goods from one location to another. Sleds may be used for recreation. Recreational sledding may be performed in a prone or seated position and involves starting at a higher elevated position and riding the sled to a lower elevated position, picking up speed from the influence of gravity. Recreational sledding may also be performed by attaching a sled to a motorized vehicle and pulling the sled around on a generally flat surface.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective view of a steerable sledding system, according to certain embodiments.

FIG. 2 illustrates a top view of a steerable sledding system, according to certain embodiments.

FIG. 3 illustrates a bottom view of a steerable sledding system, according to certain embodiments.

FIG. 4 illustrates a front view of a steerable sledding system, according to certain embodiments.

FIG. 5 illustrates a back view of a steerable sledding system, according to certain embodiments.

FIG. 6 illustrates a side view of a steerable sledding system, according to certain embodiments.

FIG. 7A illustrates a cross-sectional front view of a runner disposed through a slot of a platform structure, according to certain embodiments.

FIG. 7B illustrates a cross-sectional exploded front view of a runner and a platform structure, according to certain embodiments.

FIG. 8A illustrates a cross-sectional side view of a connecting device connecting a steering structure with a platform structure, according to certain embodiments.

FIG. 8B illustrates a cross-sectional exploded side view of a connecting device, steering structure, and a platform structure, according to certain embodiments.

FIG. 9A illustrates a cross-sectional side view of a connecting device connecting a steering structure with a platform structure, according to certain embodiments.

FIG. 9B illustrates a cross-sectional exploded side view of a connecting device, a steering structure, and a platform structure, according to certain embodiments.

FIGS. 10-16 show views of a sled, according to certain embodiments.

### DETAILED DESCRIPTION OF EMBODIMENTS

Embodiments described herein are related to a steerable sledding system. Sleds may be used for conveying goods or passengers. A sled may have a smooth flat surface on the bottom to prevent friction and to slide smoothly. Handles may be a part of a sled for a passenger to hold onto while riding. Runners may be used on the bottom surface of a sled to provide a sharp edge than can cut through the ground to provide a smooth riding experience. Sleds may be designed for speed, size of a passenger, and number of passengers. A sled may include a single platform for a single rider or multiple subparts attached together to allow for multiple riders.

Conventionally, sleds are designed for a smooth, fast riding experience with little to no design focus on steering ability and directional control. Some conventional sleds include one structure (i.e. a saucer or a toboggan) and are designed to follow a straight path when ridden. Some conventional sleds are capable of following the contour of a slope while traveling down a sloped riding surface. Regarding the directional control of most sleds, conventionally, passengers can adjust their weight distribution, make sudden motions (e.g., a quick, sharp pull, thrust, twist, jerking motion, or the like), and contact the ground (e.g., dragging a foot or hand on the ground) to affect the direction of travel. These conventional sleds are not reliable for precise, consistent directional control, especially at high speeds. Making sudden motions to attempt to steer a conventional sled can cause flipping of the sled and injury to the passenger. Contacting the ground with a body part (e.g., foot or hand) can also lead to injury of the passenger. The inability of conventional sleds to effectively maneuver a sled can be dangerous and injure a passenger if unwanted terrain, debris, or other features on the slope are in the travel path of the sled. Some conventional sleds utilize a braking apparatus on a side of the sled to provide drag to turn the body of the sled while traveling. However, these types of conventional sleds may have a large reduction of speed to adequately turn which hinders the enjoyment of the passenger. The braking apparatus may also be prone to wearing down and breaking due to the forces exerted on the braking apparatus. A braking apparatus that suddenly brakes may also cause injury to users.

The devices and systems disclosed herein provide a steerable sledding system that enables a rider of the sledding device to control the direction of travel. The steerable sledding system may be configured to receive precise turning motions from a passenger without the loss of substantial speed. The steerable sledding system may have two structures (i.e. a steering structure and a platform structure) that are capable of pivoting relative to each other allowing the passenger control over the direction the sled is traveling. Additionally, the steerable sledding system may have sidewalls that protect the rider from ground surface debris (e.g. snow and dirt), and protect the rider from being pinched or painfully contacted from the pivoting elements of the system. For example, the steerable sledding system may have a sidewall that is disposed above the surface where the rider is supported to prevent debris and harmful terrain from reaching or contacting the rider from one or more sides of the steerable sledding system.

The steerable sledding system may include a steering structure configured to enable a user to steer the steerable sledding system. The steering structure may include a first substantially horizontal portion that forms a first rear edge of the steering structure. The first substantially horizontal portion may form a first opening proximate the first rear edge. The steering structure may further include first curved sidewalls that extend upward from the substantially horizontal portion to form a front edge and two side edges. The steerable sledding system may further include a platform structure configured to support the user of the steerable sledding system. The platform structure may form a second opening proximate a second front edge of the platform structure. The steerable sledding system may further include a connection device (e.g., pivoting device) configured to connect the steering structure and the platform structure via the first opening and the second opening to enable the steering structure and the platform structure to pivot relative to each other. In some embodiments, the connection device may enable the steering structure and the platform structure to move in at least two degrees of freedom relative to each other. In some embodiments, the steering structure may have a first substantially uniform thickness and the platform structure may have a second substantially uniform thickness.

The devices, systems, and methods disclosed herein have advantages over conventional solutions. The steerable sledding system may provide a passenger with precise directional control over the steerable system. The steerable sledding system may be steerable without the use of dragging an additional element (e.g., brake, etc.) on the ground, adjusting weight distribution of the passenger, sudden movement from the passenger, and/or the passenger physically contacting the ground themselves which each could otherwise cause injury or harm to the passenger. The steerable sledding system may include a steering structure that does not use a major reduction in speed to effectively maneuver. The steerable sledding system may also include sidewalls on one or more sides of the steerable sledding system to protect the passengers from unwanted contact from surface debris (e.g. snow, dirt, etc.) or other surface features (trees, rocks, e.g.).

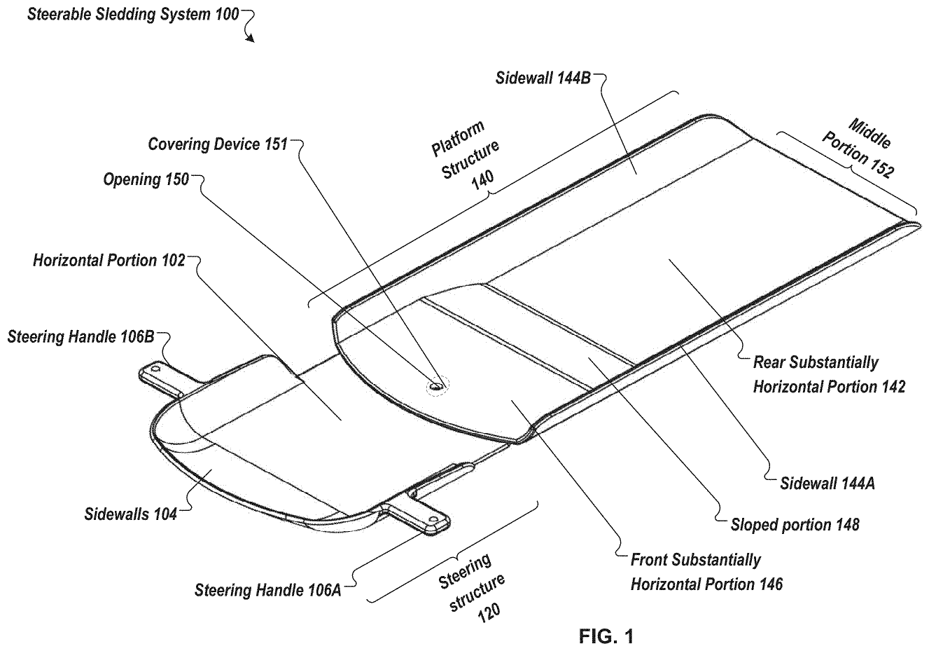

FIG. 1 illustrates a steerable sledding system 100, according to certain embodiments. The steerable sledding system 100 may include a steering structure 120 and a platform structure 140. The steering structure 120 may include a substantially horizontal portion 102, sidewalls 104, and one or more steering handles 106. The steering structure may be designed to pivot relative to the platform structure 140.

In one embodiment, the steering structure 120 may be one integrated body such that the sidewalls 104, the steering handles 106, and the substantially horizontal portion 102 are one unit. The steering structure 120 may be composed of entirely the same material. For example, the steering structure could be made of wood, plastic, steel, fiberglass, or a lightweight plastic polymer. The steering structure 120 could, in part or in its entirety, have uniform thickness. For example, the substantially horizontal portion 102, the sidewalls 104, and the steering handles 106 could independently have uniform thickness or any combination of the elements of the steering structure 120 could have uniform thickness. The sidewalls 104 could have the same uniform thickness as the substantially horizontal portion 102. The steering structure 120 may include a flexible material that is capable of withstanding forces (e.g., absorbing impact, undergoing torque, etc.) at one or more of the substantially horizontal portion 102, the sidewalls 104, and the steering handles 106 without breaking.

The substantially horizontal portion 102 may be rectangular in shape with the width long enough to support the width of a passenger of the steerable sledding system 100. The substantially horizontal portion 102 may form a rear edge and the sidewalls 104 may form a front edge, a first side edge, and a second side edge. For example, the edges may include a sloped edge. The substantially horizontal portion 102 may be disposed above or below the platform structure 140. A surface of the substantially horizontal portion 102 may make contact with a surface of the platform structure 140 (e.g., while stationary, while pivoting relative to each other). For example, an upper surface of the substantially horizontal portion 102 may make contact with a lower surface of the platform structure 140.

In some embodiments, the surface of the substantially horizontal portion 102 and/or the surface of the platform structure 140 that make contact with each other may be made out of and/or may be coated with a low friction material (e.g., that has a low coefficient of friction) to minimize friction (e.g., provide minimal friction) between the steering structure 120 and the platform structure 140 while pivoting the two structures. For example, a steerable sledding system 100 with a low coefficient of friction between the substantially horizontal portion 102 and the platform structure 140 may be used by users that want to control steering (e.g., pivot) with lower amounts of force (e.g., more experienced users).

In some embodiments, the surface of the substantially horizontal portion 102 and/or the surface of the platform structure 140 that make contact with each other may be made of or may be coated with a high friction material (e.g., that has a high coefficient of friction) to increase the force needed to pivot the steering structure 120 relative to the platform structure 140. For example, a steerable sledding system 100 with a high coefficient of friction between the substantially horizontal portion 102 and the platform structure 140 may be used by users that only want the steering to change (e.g., to pivot) with higher amounts of force (e.g., less experienced users, children, more than one user on the steerable sledding system 100).

In some embodiments, the sidewalls 104 may be selectively removable from the substantially horizontal portion 102. In some embodiments, the sidewalls 104 and the substantially horizontal portion 102 are integral to each other. In some embodiments, the sidewalls 104 are disposed on a front edge and one or more side edges of the substantial horizontal portion 102. In some embodiments, the sidewalls 104 may be disposed solely on the front side of the substantially horizontal portion 102 without extending to the side edges of the substantially horizontal portion 102. The sidewalls 104 may include one or more slopes. In some embodiments, the sidewalls 104 may substantially vertical (e.g., a substantially vertical wall) and may form approximately a right angle (e.g., 90-degree angle) with the substantially horizontal portion 102 (e.g., sidewalls 104 may meet the substantially horizontal portion at approximately a right angle). In another example, the sidewalls 104 may include an upward slope (e.g., curved sidewalls). The sidewalls 104 may have a first distal end (e.g., coupled to the substantially horizontal portion 102) that is in a plane substantially perpendicular to an upper surface of the substantially horizontal portion 102. The sidewalls 104 may have a second distal end (e.g., an outer edge) that lies in a plane substantially parallel to the upper surface of the substantially horizontal portion 102. The sidewall 104 may extend along the front edge and at least a portion of the side edges of the substantially horizontal portion 102 (e.g., extending to be proximate the sidewalls 144 of the platform structure 140). In one embodiment, the sidewalls 104 of the steering structure 120 may extend slightly off the ground such that the sidewalls 104 are still substantially parallel to the ground surface below the steerable sledding system 100. In other embodiment, the sidewalls 104 may extend to a distal edge that is about one foot above the substantial horizontal portion 102. For example, the sidewalls 104 may extend upward to a distal edge that is approximately the height of the shoulders of a passenger while the passenger is in the prone position.

In some embodiments, the steering handles 106 may be separate from the steering structure and may be selectively coupled or affixed to the sidewalls 104 or the substantially horizontal portion 102. The steering handles 106 may be selectively extendable. In some embodiments, the steering handles 106 may be moveable (e.g., capable of bending, folding, etc.) to be parallel to the edge of the sidewalls 104 or the edge of the substantially horizontal portion 102. For example, the steering handles 106 may be designed to fold substantially flush against the sidewalls 104 of the steerable sledding system 100 when not in use. The steering handles 106 may form an opening (e.g., a channel) to receive a steering mechanism (e.g., rope, cord, etc.) that can be used to maneuver the steerable sledding system 100 (e.g., when in a feet-first position). For example the opening may receive a rope that is designed to reach a passenger who may be sitting on the sled and used to steer the steerable sledding system 100. In some embodiments, the steering handles 106 may be disposed proximate the top edge of the sidewalls 104. In other embodiments, the steering handles 106 may be disposed at a lower height (e.g., between the top edge and the bottom edge of the sidewalls 104). For example, the steering handles 106 may be disposed at a height customized to the size of the passenger such as at shoulder level.

The steerable sledding system 100 may include a platform structure 140 configured to support a passenger. A user may sit on the platform structure 140 with their legs extending towards the steering structure 120 (e.g., feet disposed on the steering handles 106) or a user may lay on the platform structure 140 with their head proximate the steering structure 120 and their hands holding the steering handles 106. The platform structure 140 may include an opening 150 near a front side of the platform structure 140 (e.g., proximate the steering structure 120). The platform structure 140 may also include a middle portion 152. The middle portion 152 may include a rear substantial horizontal portion 142 (e.g., second substantial horizontal portion), a sloped portion 148, and a front substantial horizontal portion 146 (e.g. third substantial horizontal portion).

The middle portion 152 may form a front edge and a rear edge of the platform structure 140. Sidewalls 144 may extend upward from the middle portion 152 to form side edges of the platform structure 140. In some embodiments, the sidewalls 144 extend the full length of the platform structure 140 (e.g., full length of the middle portion 152). In some embodiments, the sidewalls 144 only extend a portion of the length of the platform structure 140 (e.g., full length of the middle portion 152). For example, the sidewalls 144 can extend from the front of the platform structure 140 until three-quarters the length. In another example, the sidewalls may be custom fitted to extend to the length of a passenger in a prone position on the steerable sledding system 100. In some embodiments, the sidewalls 114 may include one or more slopes. In some embodiments, the sidewalls 144 may be substantially vertical (e.g., a substantially vertical wall) and may form approximately a right angle (e.g., 90-degree angle) with the middle portion 152 (e.g., sidewalls 144 may meet the middle portion 152 at approximately a right angle). In another example, the sidewalls 144 may include an upward slope (e.g., curved sidewalls). The sidewalls 144 may have a first distal end (e.g., coupled to the middle portion 152) that is in a plane substantially perpendicular to an upper surface of the middle portion 152. The sidewalls 144 may have a second distal end (e.g., an outer edge) that lies in a plane substantially parallel to the upper surface of the middle portion 152. The sidewall 144 may extend along the front edge and at least a portion of the side edges of the middle portion 152 (e.g., extending to be proximate the sidewalls 144 of the platform structure 140). In one embodiment, the sidewalls 144 of the platform structure 140 may extend slightly off the ground such that the sidewalls 144 are still substantially parallel to the ground surface below the steerable sledding system 100. In some embodiments, the sidewalls 144 may extend to a distal edge that is about one foot above the middle portion 152. For example, the sidewalls 144 may extend upward to a distal edge that is approximately the height of the shoulders of a passenger while the passenger is in the prone position.

In some embodiments, the platform structure 140 may include any combination of a rear substantial horizontal portion 142, a front substantial horizontal portion 146, and/or a sloped portion 148. Each of the rear substantial horizontal portion 142, the front substantial horizontal portion 146, and/or the sloped portion 148 may each include curves, indentions, or extensions to improve the stability of a passenger on the sled. For example, each of the rear substantial horizontal portion 142, the front substantial horizontal portion 146, and/or the sloped portion 148 may include a curve top surface that is deepest at the center of the middle portion 152 designed to support a passenger. In another example, each of the rear substantial horizontal portion 142, the front substantial horizontal portion 146, and/or the sloped portion 148 may include small indentions where portions of the passenger can engage (i.e. feet, knees, elbows, and arms) such that the sled is more comfortable and provides greater stability to the passenger. The sloped portion 148 may include a flat slope, an arc slope, or linear slope and may connect the rear substantial horizontal portion 142 to the front substantial horizontal portion 146. The front substantial horizontal portion may form an opening that is designed to receive connecting device (e.g. pivoting device).

In some embodiments, the platform structure 140 includes one integral unit such that the sidewalls 144 and the middle portion 152 (e.g., the rear substantial horizontal portion 142, the sloped portion 148, and the front substantial horizontal portion 146) are integral to each other (e.g., integrated to form the platform structure 140). In some embodiments, one or more of the sidewall 144, the rear substantial horizontal portion 142, the sloped portion 148, and the front substantial horizontal portion 146 are selectively removable from each other.

In some embodiments the steering structure 120 and the platform structure 140 have substantially similar width. For example, the portion of the sidewalls 104 along the sides of the substantially horizontal portion 102 of the steering structure 120 and the sidewalls 114 of the platform structure 140 may be aligned (e.g., may be coplanar) to provide protection for the user from one or more of snow, debris, or slope surface features (e.g., prevent objects from reaching a passenger).

In some embodiments, the steering structure 120 pivots relative to the platform structure 140. The sidewalls 104 of the steering structure 120 may contact a sidewall 144 of the platform structure 140. The range of motion and the capability of the sidewalls 104 engaging with the sidewalls 144 may prevent surface debris (e.g., snow, dirt, etc.) from contacting the upper surfaces of the steerable sledding system 100 (e.g., the substantially horizontal portion 102 and middle portion 152) while turning the steerable sledding system 100.

In some embodiments, the platform structure 140 may be composed of entirely the same material. For example, the platform structure 140 could be made of wood, plastic, steel, fiberglass, or a lightweight plastic polymer. The platform structure 140 could, in part or in its entirety, have a uniform thickness. The platform structure 140 may include a flexible material that is capable of withstanding forces (e.g., absorbing impact, undergoing torque, etc.) from the rear substantially horizontal portion 142, the sidewalls 144, the front substantial horizontal portion 146 and the sloped portion 148.

In some embodiments, the steering structure 120 (e.g., sidewalls 104 and substantially horizontal portion 102) may have a substantially uniform thickness. In some embodiments, the platform structure 140 (e.g., middle portion 152 and sidewalls 144A-B) may have a substantially uniform thickness. In some embodiments, a first thickness (e.g., a first substantially uniform thickness) of the steering structure 120 may be substantially equivalent to a second thickness (e.g., a second substantially uniform thickness) of the platform structure 140. In some embodiments, corresponding thicknesses of two or more of the sidewalls 104, substantially horizontal portion 102, sidewalls 144A-B, and/or middle portion 152 are substantially the same thickness (e.g., substantially uniform thickness). In some embodiments, the corresponding uniform thickness of the steering structure 120 and/or the platform structure 140 is a value from about 0.25 inch to about 0.375 inches. In some embodiments the corresponding uniform thickness of the steering structure 120 and/or the platform structure 140 is a value from about 0.25 inch to about 0.5 inch. In some embodiments, the steering structure 120 and/or the platform structure 140 each have a corresponding uniform thickness that is a value of 1 inch or less. In some embodiments, the steering structure 120 is connected to the platform structure 140 by a connection device such that the steering structure 120 and the platform structure 140 are connected to each other and are able to move relative to each other. For example the connection device may include a pivoting device that is configured to connect the steering structure 120 with the platform structure 140 such that the steering structure 120 may pivot relative to the platform structure 140.

In some embodiments, the platform structure 140 may include a covering device 151 that is configured to cover the opening 150 (e.g., and the connecting device). The covering device 151 may be configured to protect a passenger of the steerable sledding system 100 from unwanted contact from the connection device.

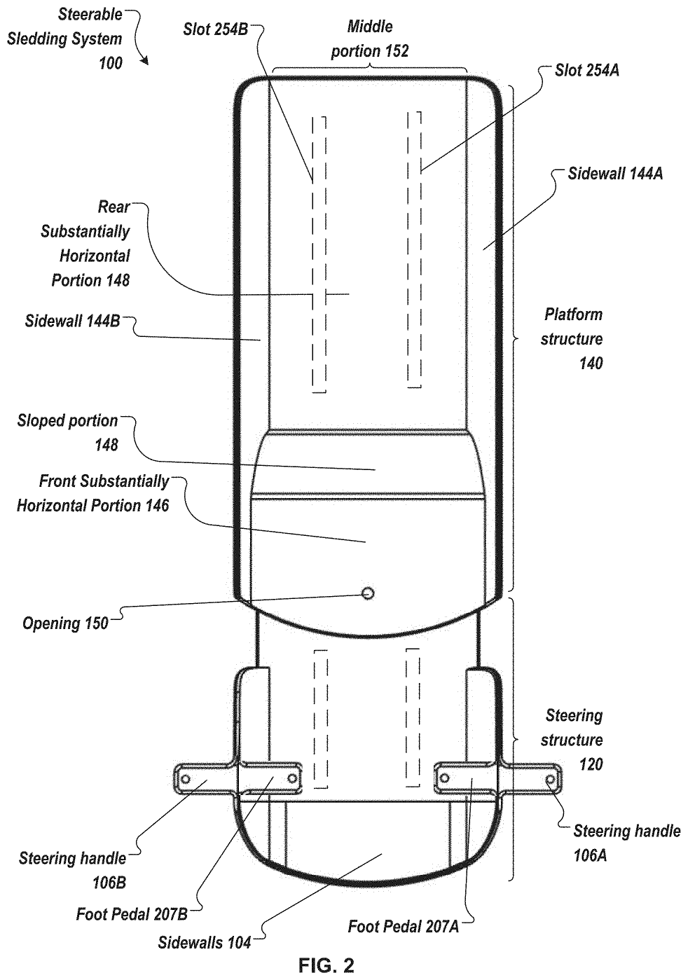

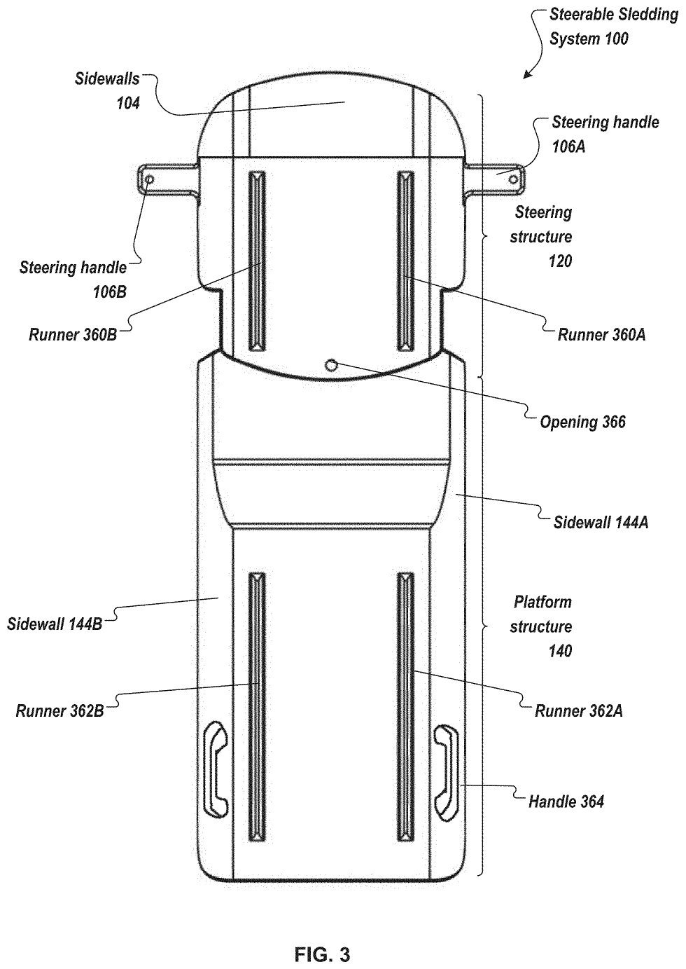

FIG. 2 illustrates a top view of a steerable sledding system 100 according to certain embodiments. Some elements in FIG. 2 may have the same number as other figures, and these elements may be substantially similar to those elements having the same number in other figures. The steerable sledding system 100 may include a steering structure 120 and a platform structure 140. The steerable sledding system 100 may further include a connection device (e.g. pivoting device) configured to couple the platform structure 140 and the steering structure to each other via an opening 150 formed by the platform structure 140 and an opening (e.g., see opening 366 of FIG. 3) formed by the steering structure 120 (underneath the opening 150).

In some embodiments, the platform structure 140 may include a rear substantially horizontal portion 142, a sloped portion 148, and a front substantially horizontal portion 146. The rear substantially horizontal portion 142 may form one or more slots 254. The sloped portion 148 may include a first end and a second end such that the first end is proximate to the rear substantially horizontal portion 142 and the second end is proximate to the front substantially horizontal portion 146. In some embodiments, the first end of the sloped portion 148 is lower than the second end of the sloped portion 148. The slope portion 148 is configured to connect the rear substantially horizontal portion 142 to the front substantially horizontal portion 146 such that the front substantially horizontal portion 146 is elevated above the steering structure 120.

The one or more slots 254 formed in the middle portion 152 may be configured (e.g., sized and shaped) to receive devices configured to contact the ground surface (e.g. runners). For example, each slots 254 may form an opening (e.g., rectangular opening, elliptical opening, curved opening, triangular opening, etc.) in the middle portion 152 with a long side parallel to the sidewalls 144 of the platform structure 140. The one or more slots 254 may be custom shaped such that a corresponding runner (e.g., see runners 362 of FIG. 3) can be disposed through each slot 254. Perimeter edges of the runner may be in contact with the sidewalls of the slot (e.g., the runner may be in close proximity with all the edges of the slot 254 formed by the platform structure 140). For example, a slot 254 may be formed in the shape of the outside edge of a runner. In some embodiments, the one or more slots 254 are disposed relatively parallel to the long side of the middle portion 152. In some embodiments, the one or more slots may be disposed parallel to the edge of the platform structure 140. In some embodiments, the slots 254 are disposed such that the distal end of the slots closest to the rear of the platform structure are further away from the middle of the middle portion 152 than the distal end of the slots 254 closer to the sloped portion 148. In some embodiments, the distal end of the slots 254 closest to the sloped portion 148 are closer to the middle of the middle portion 152 than the distal end of the slots 254 closest to the rear of the platform structure 140. The one or more slots 254 may be configured to receive and engage with runners (e.g., see runners 362 of FIG. 3). The runners may have a flange that engages with (e.g., and is secured to, is fastened to) the upper surface of the middle portion 152 and a protrusion that extends through the platform structure 140 (e.g., that extends to an area under the platform structure 140). In some embodiments, the steering structure 120 and the platform structure 140 may each comprise runners integral to the steering structure 120 or the platform structure 140.

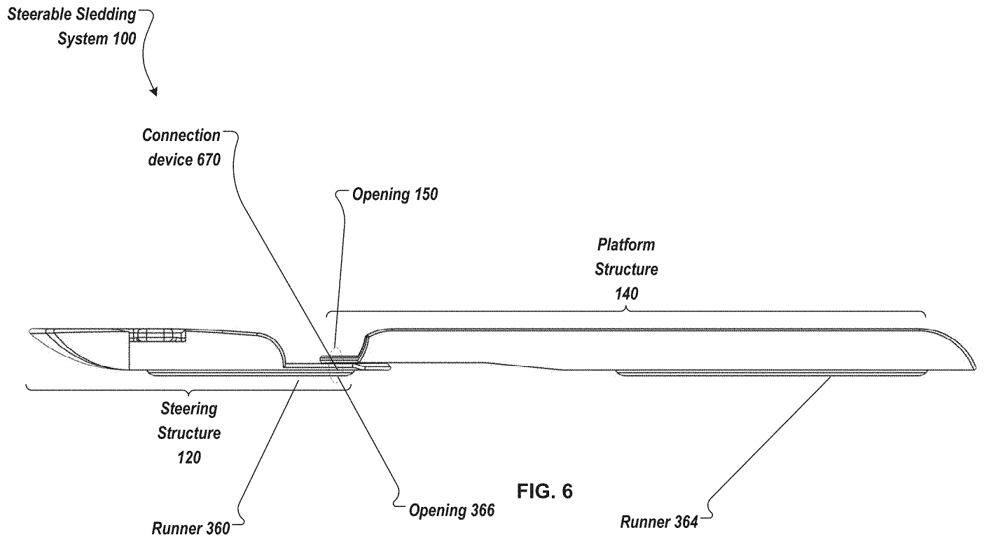

In some embodiments, the platform structure 140 may include a covering device (e.g., see covering device 151 of FIG. 1) configured to cover the opening 150 and shield the passenger from any unwanted contact (e.g., pinching, snagging, scraping) from the connection device (e.g., see connection device 670 of FIG. 6) used to connect the steering structure 120 and the platform structure 140. For example, the cover may protect the rider from any pinching from the connection device that enables the steering structure 120 and/or the platform structure 140 to pivot relative to each other when turning or maneuvering the steerable sledding system 100.

In another embodiment, the steering structure 120 may include one or more foot pedals 207. The foot pedal may include an elongated portion that is disposed on the inside of the sidewalls 104. The foot pedal may be selectively removable, affixed to, or integrated into the steering structure 120. The foot pedals 207 are configured to engage with a passenger's foot. In some embodiments, the foot pedals 207 are designed to enable the passenger to maneuver the steerable sledding system 100 with their feet.

FIG. 3 illustrates a bottom view of a steerable sledding system 100, according to certain embodiments. Some elements in FIG. 3 may have the same number as other figures, and these elements may be substantially similar to those elements having the same number in other figures. The steerable sledding system 100 may have a steering structure 120 and a platform structure 140. The steering structure 120 may include a bottom surface that is coupled to (e.g., fastened to, integral with) one or more runners 360 (e.g., two runners). The platform structure 140 may include a bottom surface that is coupled to (e.g., fastened to, integral with) one or more runners 362 (e.g., two runners).

In some embodiments, the one or more runners 360 are integral to the steering structure 120. In some embodiments, the runners 360 are selectively removable from the steering structure 120. The runners 360 may be selectively removable by using a connecting element (e.g., fastener, screw, bolt, etc.). For example, the runners 360 may be screwed in the bottom side of the steering structure 120. In some embodiments, the runners 360 are attached to the bottom side of the steering structure 120 with the use of an adhesive. In some embodiments, the runners 360 are positioned on the bottom side of the steering structure 120 with no connecting elements or protrusions used on the bottom side of the steering structure 120. For example, each runner 360 may extend through a corresponding slot (e.g., see slots 254 of FIG. 2) and a portion (e.g., flange) of each runner may be coupled to (e.g., adhere or be affixed to) a top surface of the steering structure 120. By coupling a portion of each runner 360 to the upper surface of the steering structure 120, drag caused by elements on the bottom of the steering structure 120 (e.g., elements that are used to adhere or connect the runners 360 under the steering structure 120) is minimized. The runners 360 may be selectively removed to enable customization of runners for different weather conditions, surface types, user preferences (e.g., speed vs. control), etc.

In some embodiments, the one or more runners 362 are integral to the platform structure 140. In some embodiments, the runners 362 are selectively removable from the platform structure 140. The runners 362 may be selectively removable by using a connecting element (e.g., fastener, screw, bolt, etc.). For example, the runners 362 may be screwed in the bottom side of the platform structure 140. In some embodiments, the runners 362 are attached to the bottom side of the platform structure 140 with the use of an adhesive. In some embodiments, the runners 362 are positioned on the bottom side of the platform structure 140 with no connecting elements or protrusions used on the bottom side of the platform structure 140. For example, each runner 360 may extend through a corresponding slot (e.g., see slots 254 of FIG. 2) and a portion (e.g., flange) of each runner may be coupled to (e.g., adhere or be affixed to) an upper surface of the platform structure 140. By coupling a portion of each runner 362 to the upper surface of the platform structure 140, less friction occurs between elements associated with the platform structure 140 and the ground (e.g., no fasteners, etc. are between the bottom surface of the platform structure 140 and the ground). The runners 362 may be selectively removed to enable customization of runners for different weather conditions, surface types, user preferences (e.g., speed vs. control), etc.

In some embodiments, one or more runners are removably attached to the steerable sledding system 100 and one or more runners are integral to the steerable sledding system 100. For example, at least one runner (e.g., one runner, two runners, etc.) is integral to the steering structure 120 and at least runner (e.g., one runner, two runners, etc.) is removably attached to the platform structure 140.

In some embodiments, the platform structure 140 may include one or more handles 364. The platform structure 140 may include sidewalls 144 that provide one or more handles 364. In some embodiments, the one or more handles 364 may extend from an inside surface of the sidewalls 144, extend from an outside surface of the sidewalls 144, or be integrated within (e.g., formed by) the sidewalls 144 (e.g., an opening formed by the sidewalls 144). In some embodiments, the one or more handles 364 may be integrated directly into the middle portion 152 of the platform structure 140. For example, the handle 364 may be a protrusion in the middle portion 152 that is configured to be held. In another example, the handle may be a recess formed by the middle portion 152. In another example, the handle 364 may include a cord or rod accessible by the passenger while riding the steerable sledding system 100. The handle 364 may be integrated into the platform structure 140 or may be a separate unit capable of being selectively removed or affixed to the platform structure 140. In some embodiments, the platform structure 140 may have multiple handles 364 to provide stability to one or passengers while riding the steerable sledding system 100. For the handles 364 may be disposed along the inside surface of the sidewalls 144 to be lined up with the shoulders of a passenger. In another example, the sidewalls 144 may include two sets of handles line up in close proximity to the hands of multiple passengers of the steerable sledding system 100.One or more handles 364 on the outside can be used to assist in transporting (e.g., carrying by hand, attaching to a vehicle) the steerable sledding system 100 when not being ridden. For example, the handles 364 may be disposed on the outside of the sidewall 144 lined up with the sloped portion 148 of the platform structure 140

In some embodiments, each of the runners 360 and 362 may include a long blade that has a sharp ridge designed to contact the surface on which the steerable sledding system 100 is disposed. Each of the runners 360, 362 may come to a point on a front side (e.g., closest to the sidewalls 104). The steerable sledding system 100 may include runners 360 or 362 that are different shapes and sizes to be used simultaneously. For example, a runner 360 or 362 (e.g. a first runner) coupled to a structure (e.g., steering structure 120 or platform structure 140) may be longer than or curved relative to a runner 360 or 362 (e.g. a second runner) coupled to the same structure. The combination of various types, sizes, shapes, and material composition of runners may be used to optimize performance in different weather conditions, slope surface conditions, and passenger parameters (i.e. height, weight, body shape).

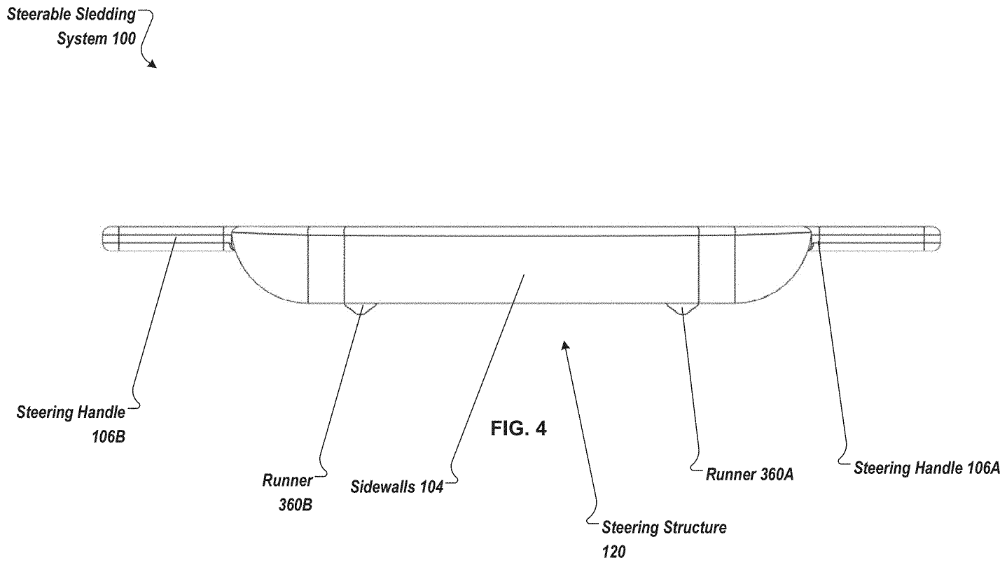

FIG. 4 illustrates a front view of a steerable sledding system 100 according to certain embodiments. Some elements in FIG. 4 may have the same number as other figures, and these elements may be substantially similar to those elements having the same number in other figures. The steerable sledding system 100 may include steering handles 106, a set of runners 360, sidewalls 104 on a front side of the steerable sledding system 100.

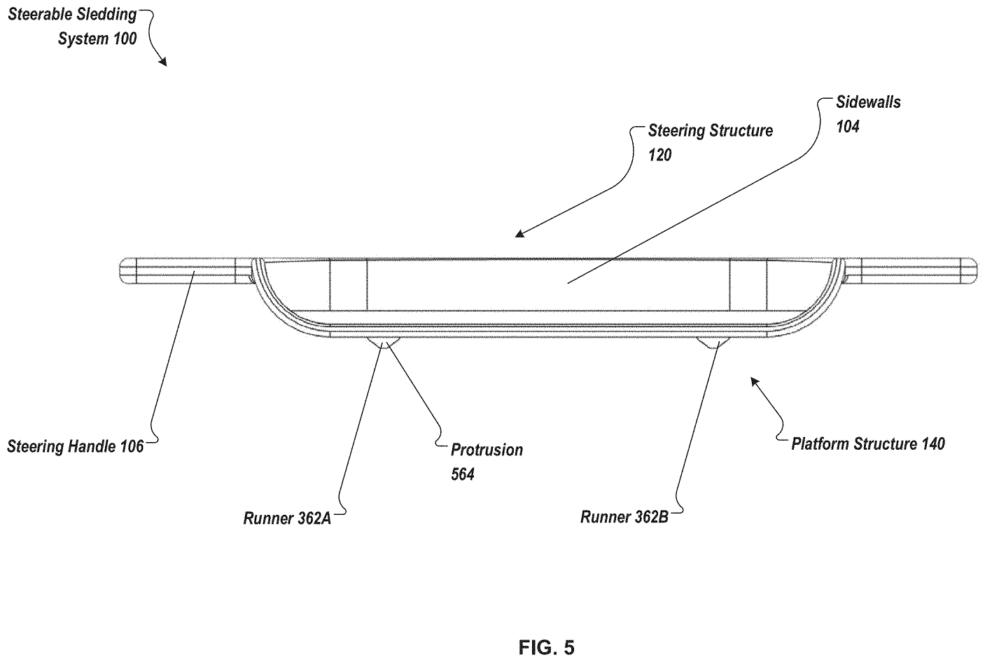

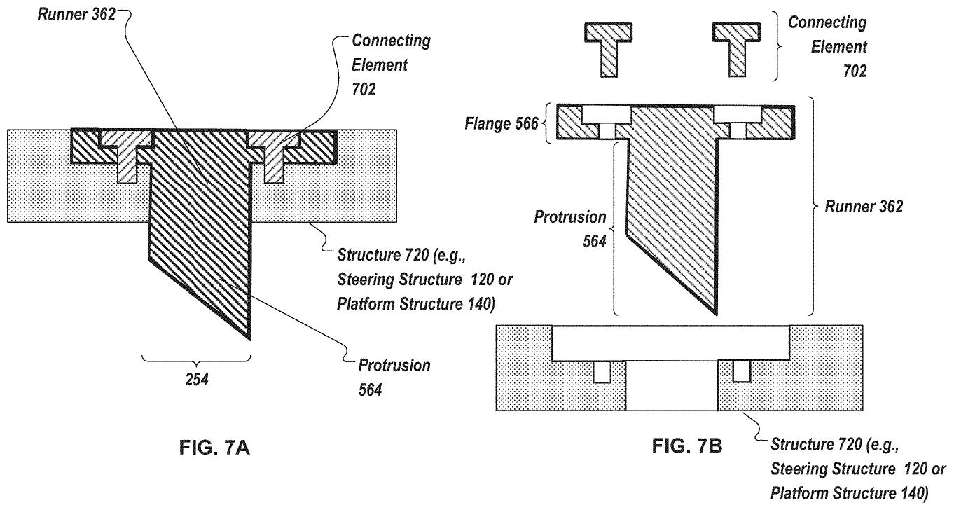

FIG. 5 illustrates a back view of a steerable sledding system 100, according to certain embodiments. Some elements in FIG. 5 may have the same number as other figures, and these elements may be substantially similar to those elements having the same number in other figures. The steerable sledding system 100 may include a steering structure 120 and a platform structure. The steering structure 120 may include one or more steering handles 106, and a sidewall 104.The platform structure 140 may include and a set of runners 362. In some embodiments, the runners 362 may be integral to the body of the steerable sledding system 100. In some embodiments, the runners 362 may be affixed to and/or selectively removable from the platform structure 140. The runners 362 may be attached from a top side of the steerable sledding system 100. For example, each runner may include a flange (e.g., see flange 566 of FIG. 7B) and a protrusion 564 and may be configured to fit within a slot of the platform structure (e.g., see slot 254 of FIG. 2). The flange (e.g., see flange 566 of FIB. 7B) may be designed to engage with a top side of the steerable sledding system 100 while the protrusion 564 may be designed to extend through the slot to the bottom side of the steerable sledding system 100 and contact the surface (e.g., snow, sand, ice) on which the steerable sledding system 100 is disposed.

FIG. 6 illustrates a side view of a steerable sledding system 100, according to certain embodiments. Some elements in FIG. 6 may have the same number as other figures, and these elements may be substantially similar to those elements having the same number in other figures. The steerable sledding system 100 may include a steering structure 120 and a platform structure 140. The steering structure 120 may include a set of runners 360 extending from a bottom surface of the steering structure 120. The platform structure 140 may include runners 362 extending from a bottom surface of the platform structure 140. The steering structure 120 may form an opening 366 proximate a rear edge of the steering structure 120. The platform structure 140 may form an opening 150 proximate a front edge of the platform structure 140. In some embodiments, the steering structure 120 may engage the platform structure 140 by having a portion of the steering structure 120 that overlaps a portion of the platform structure 140. The overlapping portion of the steering structure 120 may be disposed above or below the overlapping portion of the platform structure 140. In another embodiment an edge of the steering structure 120 may engage with or be in close proximity to an edge of the platform structure 140.

The steerable sledding system 100 may include a connection device 670 that engages a steering structure 120 with a platform structure 140. In one embodiment, the connection device 670 may be a pivoting device that enables the steering structure 120 and/or platform structure 140 to pivot or rotate relative to each other. In some embodiments, the connection device 670 may include a device that enables the steering structure 120 and the platform structure 140 to move with two or more degrees of freedom of motion. A degree of freedom of motion between the steering structure 120 and the platform structure 140 may include pivoting by the steering structure 120 relative to the platform structure 140 within a plane that includes the platform structure 140, pivoting by the steering structure 120 perpendicular to the plane that includes the platform structure 140, and rotating about an axis defined by the center of the middle portion 152 including the point having the connection device 670. For example, in the view of the passenger facing directly to the front of the steerable sledding system 100, a front side of the steering structure 120 is designed to move in the left and right, up and down, and/or clockwise and counterclockwise directions relative to the platform structure 140. This range of motion of the connection device 670 may enable a passenger to steer the steerable sledding system 100 down a slope by having the capability of turning the steering structure 120 in the left or right direction (e.g., to turn to the left or right) tilting the steering structure 120 in the upward and downward directions (e.g., to adjust for vertical changes in the gradient), and/or tilting the steering structure in the clockwise and counterclockwise direction (e.g., to adjust for horizontal changes in the gradient) relative to the view of a passenger facing forward in the direction of travel in the axis of the direction of travel (e.g. down the hill)

In some embodiments, the connection device 670 may include a joint having one or more of a ball and socket, a ball bearing, or multiple hinge joints. In some embodiments, the connection device 670 may include a pivoting device that engages an opening 366 on the steering structure 120 and an opening 150 on the platform structure 140. The pivoting device may include a pin, bolt, or screw. The pivoting device may be selectively removable. For example, the pivoting device may include a plug device with elongated that hold the plug in place and allow the steering structure 120 and the platform structure 140 to pivot freely

FIG. 7A illustrates a cross-sectional front view of a runner 362 disposed through a slot formed by a structure 720 (e.g., steering structure 120 or platform structure 140) of the steerable sledding system 100, according to certain embodiments. FIG. 7B illustrates a cross-sectional exploded front view of a runner 362 and a structure 720 (e.g., steering structure 120 or platform structure 140) of the steerable sledding system 100, according to certain embodiments. Some elements in FIG. 7A and FIG. 7B may have the same number as other figures, and these elements may be substantially similar to those elements having the same number in other figures. In some embodiments the runner 362 may be coupled to the structure 720 such that only a protrusion 564 of the runner 362 is disposed below the structure 720. A runner may include a protrusion 564 and a flange 566. In some embodiments, the protrusion 564 and the flange 566 are made of the same material and are integral with each other. The protrusion 564 may have a surface configured to contact the ground below the runner 362. For example, the protrusion 564 may include a sharp edge or ridge configured to contact and slide over ice or snow. In another example, the protrusion 564 may include a wheel configured to contact surfaces (e.g. gravel, rocks, grass, dirt, pavement, concrete, dry surfaces, ice, etc.).

In some embodiments the runner 362 may include a flange 566 configured to engage an upper surface of the structure 720. The flange 566 may be affixed to or removably coupled to the structure 720 by a connecting element 702 (e.g., fastener). For example, the connecting element 702 of the runner 362 may include one or more of a bolt, screw, or other selectively coupling element configured to secure the runner 362 in place and allow the runner 362 to be removed. In some embodiments, the structure 720 may form a slot and a counterbore. The runner 362 may be configured to have the protrusion 564 fit within the slot and the flange 566 fit within the counterbore. The structure 720 and the flange 566 may be configured such that when the connecting element 702 secures the flange 566 to the structure 720, an upper surface of the flange 566 is substantially coplanar with an upper surface of the platform structure (e.g., the combination creates a substantially smooth or event surface). The formed substantially smooth or even surface may protect the passenger of a steerable sledding system (See steerable sledding system 100 in FIG. 1) from being pinched or injured from the runner 362.

In some embodiments, the flange 566 may be affixed to the structure 720 through the use of an adhesive. In some embodiments the structure 720 may be the platform structure 140 or the steering structure 120 (e.g., see platform structure 140 and steering structure 120 of FIG. 1). In some embodiments, the flange 566 may have a corresponding opening to receive each connecting element 702. The flange 566 may have a counterbore to receive the head of each connecting element 702. The runner 362 may couple with the structure 720 and the connecting element 702 may engage with the flange 566 so that corresponding upper surfaces of the connecting element 702, runners 362, and structure 720 are coplanar (e.g., even).

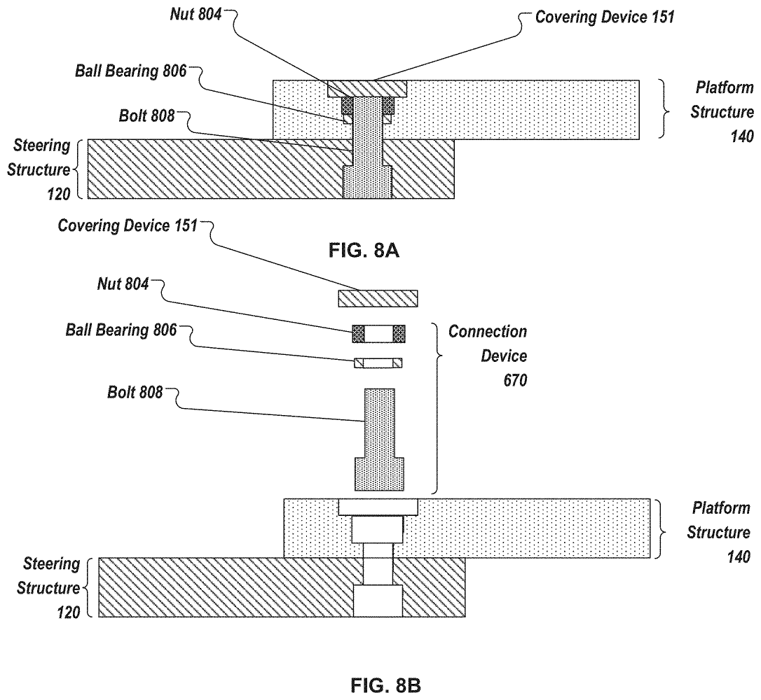

FIG. 8A illustrates a cross-sectional side view of a connection device 670 connecting a steering structure 120 with a platform structure 140, according to certain embodiments. FIG. 8B illustrates a cross-sectional exploded side view of a connection device 670, steering structure 120, and a platform structure 140, according to certain embodiments. The connection device 670 may be configured to connect a platform structure 140 and a steering structure 120. The connection device 670 may include one or more of a nut 804, ball bearing 806, and bolt 808. The connection device 670 may be a pivoting element such that when the steering structure 120 is connected to the platform structure 140, the steering structure 120 is configured to pivot relative to the platform structure 140 via the connection device 670. A covering device 151 may be disposed above the connection device 670. For example, the covering device 151 may be disposed in a recess above the connection device to protect a passenger from injury or other undesired contact from the connection device 670 (e.g., protect the passenger when the steering structure 120 is being turned relative to the platform structure 140). In some embodiments the connection is one integrated unit. For example, the connection device 670, may comprise a flexible material (e.g. rubber) such that the shape of the connection device 670 is adjusted to fit in the recess connecting the steering structure 120 and the platform structure 140. The connection device 670 may include bolts, pins, or other components known in the art that may connect two structures such that the two structures may pivot relative to each other. In some embodiments, the steering structure 120 has a bore and a counterbore. The head of the connection device 670 (e.g., bolt) may be disposed within the counterbore and a portion of the length of the connection device 670 (e.g., shank, threaded portion, etc.) may be disposed in the bore. The platform structure 140 may have a bore and one or more counterbores. A portion of the length of the connection device (670 (e.g., shank, threaded portion, etc.) may be disposed in the bore. The ball bearing 806, nut 804, and covering device 151 may be disposed in one or more corresponding counterbores. One or more of the ball bearing 806, nut 804, or covering device 151 may be disposed in the same counterbore.

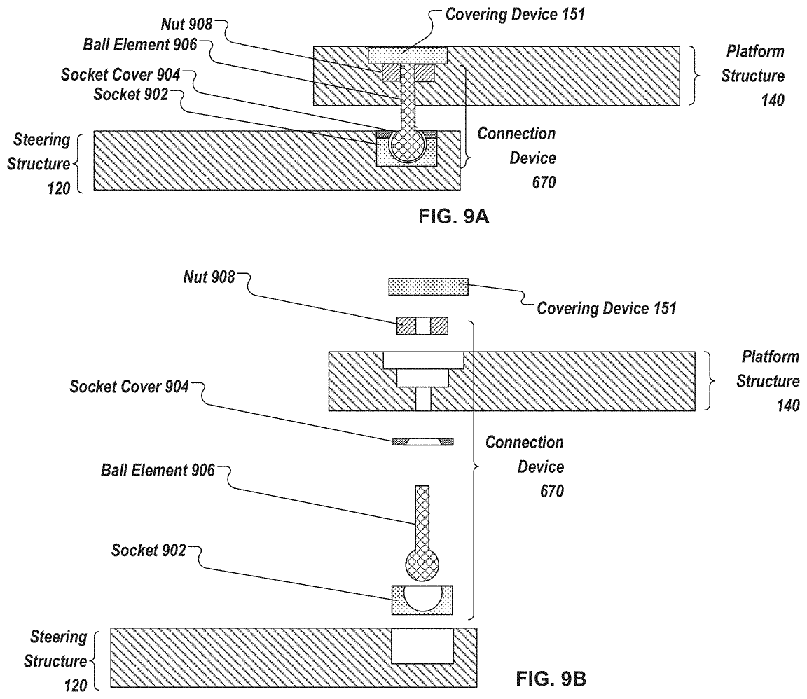

FIG. 9A illustrates a cross-sectional side view of a connection device 670 connecting a steering structure 120 with a platform structure 140, according to certain embodiments. FIG. 9B illustrates a cross-sectional exploded side view of a connection device 670, a steering structure 120, and a platform structure 140, according to certain embodiments. The connection device 670 may connect the steering structure 120 with the platform structure 140 such as to enable the steering structure 120 and the platform structure 140 to move in at least two degrees of freedom relative to each other. In some embodiments, the connection device 670 may include a socket 902, a ball element 906, and a socket cover 904 configured to hold the round portion of the ball element 906 from falling out of the socket 902. The ball element 906 may include a ball portion (e.g., head) and a length portion (e.g., shank, threaded, etc.). The ball portion of the ball element 906 may rotate within the socket 902. The rotation may allow the steering structure 120 and the platform structure 140 to move relative to each other in two or more degrees of freedom. In some embodiments, the connection device 670 is a ball-and-socket joint. In some embodiments, the connection device 670 may include a kingpin device or other device configured to connect two structures (e.g. steering structure 120 and platform structure 140) to each other and to enable motion in at least two degrees in freedom between the steering structure 120 and platform structure 140.

The steering structure 120 may include a front edge and a rear edge where the rear edge is proximate the connection device 670 and the front end is opposite the rear edge. In some embodiments, the two degrees of motion may include two or more of the front edge of the steering structure 120 moving up and down relative to the platform structure 140, the steering structure 120 pivoting left and right relative to the platform structure 140, or the steering structure 120 rotating clockwise or counterclockwise relative to the platform structure 140.In some embodiments the connection device may be covered up by a covering device 151. For example, a rider can be protected from injury or harm from the turning and pinching of the connection device 670 as the steerable sledding system 100 is being turned or maneuvered.

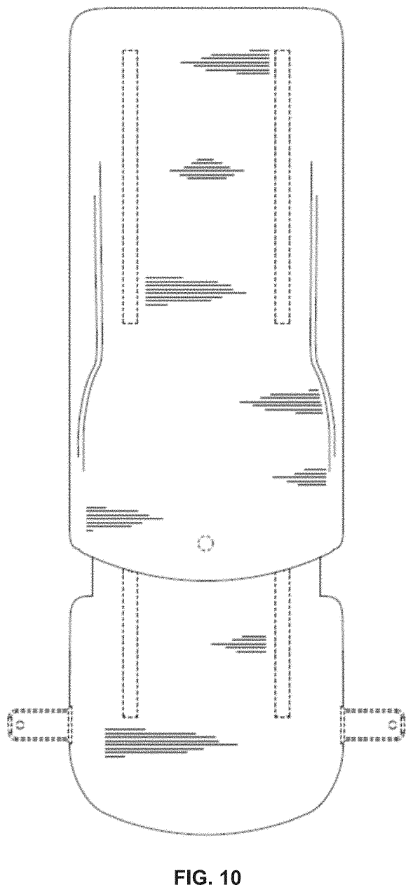

FIGS. 10-16 show views of a sled, according to certain embodiments.

FIGS. 10-16 may be directed to an ornamental design for a sled (e.g., a steerable sledding system, steerable sledding system 100 of one or more of FIGS. 1-9B). In some embodiments, the broken lines in FIGS. 10-16 may not form part of the sled (e.g., FIGS. 10-16 may illustrate a sled without one or more handles, FIGS. 10-16 may illustrate a sled with slots to insert runners) (e.g., the dashed lines may be an environmental structure, etc.). In some embodiments, one or more of the broken lines in FIGS. 10-16 may form part of the sled (e.g., FIGS. 10-16 may illustrate a sled with one or more handles, FIGS. 10-16 may illustrate a sled with one or more runners, such as one or more integral runners and/or one or more removably attachable runners).

FIG. 10 shows a top view of the sled;

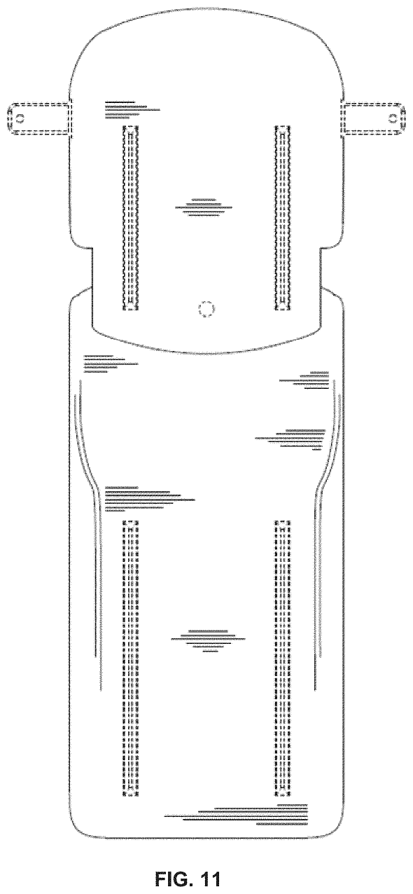

FIG. 11 shows a bottom view thereof;

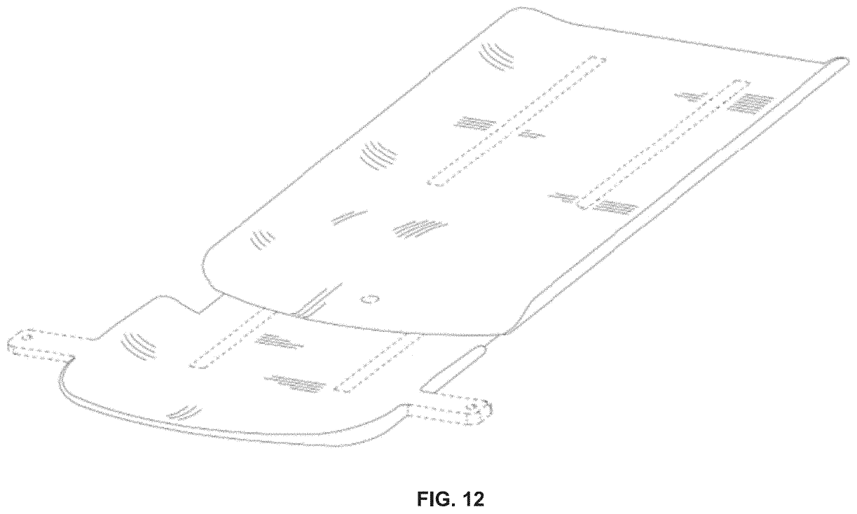

FIG. 12 shows an upper perspective view thereof;

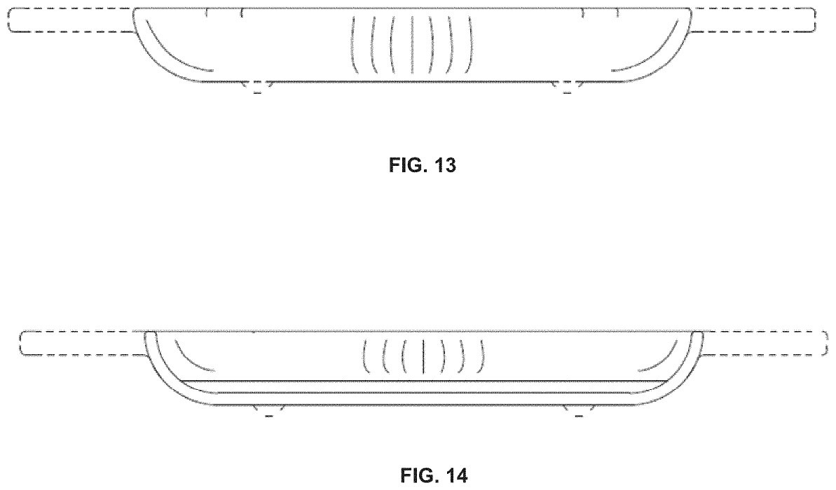

FIG. 13 shows a front view thereof;

FIG. 14 shows a back view thereof;

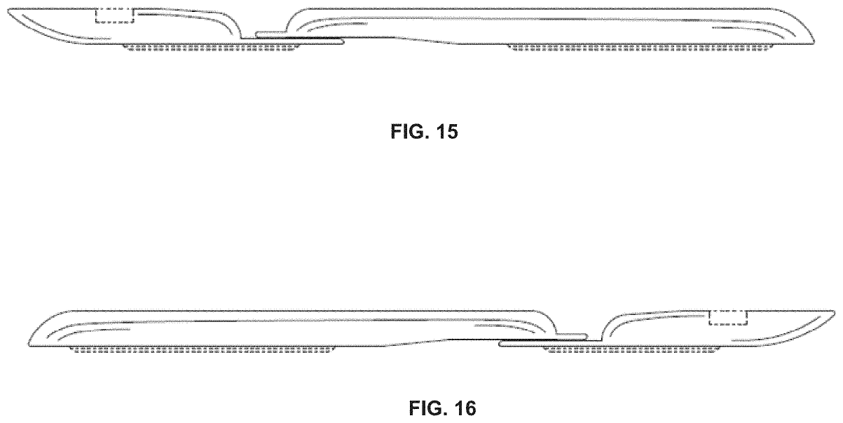

FIG. 15 shows a left side elevation view thereof; and

FIG. 16 shows a right side elevation view thereof.

The preceding description sets forth numerous specific details such as examples of specific system, components, devices and so forth in order to provide a good understanding of several embodiments of the present disclosure. It will be apparent to one skilled in the art, however, that at least some embodiment of the present disclosure may be practiced without these specific details. In other instances, well-known components or methods are not described in detail to avoid unnecessarily obscuring the present disclosure. Thus, the specific details set forth are merely exemplary. Particular implementations may vary from these exemplary details and still be contemplated to be within the scope of the present disclosure.

Reference throughout this specification to “some embodiments,” “one embodiment,” or “an embodiment” means that a particular feature, structure, or characteristic described in connection with the embodiment is included in at least one embodiment. Thus, the appearance of the phrase “in some embodiments,” “in one embodiment,” or “in an embodiment” in various places throughout this specification are not necessarily all referring to the same embodiment. Furthermore, a person having ordinary skill in the art will recognize that the elements, components, and devices found in an embodiment of the system may be combined with any element, component, or device of another embodiment and that the use of any specified element, component, or device is not isolated to the exemplary embodiment within where it is described. In addition, the term “or” is intended to mean an inclusive “or” rather than an exclusive “or.” When the term “about”, “approximately”, or “substantially” is used herein, this is intended to mean the nominal value or characteristic presented is precise within ±10%.

The terms “over,” “above” “under,” “between,” and “on” as used herein refer to a relative position of one material layer or component with respect to other layers or components. For example, one element, component, or device disposed above, over, or under another element, component, or device may be directly in contact with the other element, component, or device or may have one or more intervening elements, components, or devices. Moreover, one element, component, or device disposed between two elements, components, or devices may be directly in contact with the two elements, components, or devices or may have one or more intervening elements, components, or devices. Similarly, unless explicitly stated otherwise, one feature disposed between two features may be in direct contact with the adjacent features or may have one or more intervening features.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A steerable sledding system comprising:
a steering structure configured to enable a user to steer the steerable sledding system, the steering structure comprising:
a first substantially horizontal portion that forms a first rear edge of the steering structure, wherein the first substantially horizontal portion forms a first opening proximate the first rear edge; and
first curved sidewalls that extend upward from the first substantially horizontal portion to form a front edge, a first side edge, and a second side edge of the steering structure, wherein the front edge, the first side edge, and the second side edge are disposed above the first substantially horizontal portion;
a platform structure configured to support the user, wherein the platform structure forms a second opening proximate a second front edge of the platform structure; and
a pivoting device configured to connect the steering structure and the platform structure via the first opening and the second opening to enable the steering structure and the platform structure to pivot relative to each other.

2. The steerable sledding system of claim 1, wherein the steering structure further comprises:
a first steering handle extending from the first side edge above the first substantially horizontal portion; and
a second steering handle extending from the second side edge above the first substantially horizontal portion.

3. The steerable sledding system of claim 1, wherein the platform structure comprises:
a middle portion that forms the second front edge and a second rear edge of the platform structure, wherein the middle portion forms the second opening proximate the second front edge;
second curved sidewall that extends upward from the middle portion to form a third side edge of the platform structure; and
third curved sidewall that extends upward from the middle portion to form a fourth side edge of the platform structure, wherein the third side edge and the fourth side edge are disposed above the middle portion.

4. The steerable sledding system of claim 3, wherein the middle portion comprises:
a second substantially horizontal portion that forms the second rear edge of the platform structure;
a third substantially horizontal portion that forms the second front edge of the platform structure and the second opening; and
a sloped portion that couples the second substantially horizontal portion to the third substantially horizontal portion, wherein the second curved sidewall and the third curved sidewall extend upward from the second substantially horizontal portion, the third substantially horizontal portion, and the sloped portion.

5. The steerable sledding system of claim 3, wherein:
the first substantially horizontal portion further forms a fifth side edge and a sixth side edge;
the first curved sidewalls form a first sloped edge and a second sloped edge;
the first sloped edge is coupled between the first side edge and the fifth side edge; and
the second sloped edge is coupled between the second side edge and the sixth side edge.

6. The steerable sledding system of claim 5, wherein the steering structure is configured to pivot about the pivoting device to enable the first sloped edge to engage with a first portion of the second curved sidewall and to enable the second sloped edge to engage with a second portion of the third curved sidewall.

7. The steerable sledding system of claim 3, wherein the second curved sidewall forms one or more handles.

8. The steerable sledding system of claim 3, wherein the middle portion forms a first slot and a second slot, wherein the steerable sledding system further comprises:
a first runner comprising a first flange and a first protrusion, wherein the first flange is disposed on an upper surface of the middle portion and the first protrusion extends from the first flange through the first slot; and
a second runner comprising a second flange and a second protrusion, wherein the second flange is disposed on the upper surface of the middle portion and the second protrusion extends from the second flange through the second slot.

9. The steerable sledding system of claim 1 further comprising a covering device configured to be removably secured to the platform structure above the pivoting device.

10. The steerable sledding system of claim 1 further comprising:
a first set of runners integral to a first bottom surface of the steering structure; and
a second set of runners integral to a second bottom surface of the platform structure.

11. A steerable sledding system comprising:
a steering structure configured to enable a user to steer the steerable sledding system, wherein the steering structure forms a first opening proximate a first rear edge of the steering structure;
a platform structure configured to support the user, wherein the platform structure forms a second opening proximate a second front edge of the platform structure; and
a connection device configured to connect the steering structure and the platform structure via the first opening and the second opening, wherein the connection device enables the steering structure and the platform structure to move in at least two degrees of freedom relative to each other.

12. The steerable sledding system of claim 11, wherein the steering structure comprises:
a first substantially horizontal portion; and
first curved sidewalls that extend upward from the first substantially horizontal portion to form a front edge, a first side edge, and second side edge of the steering structure, wherein the front edge, the first side edge, and the second side edge are disposed above the first substantially horizontal portion.

13. The steerable sledding system of claim 12, wherein the steering structure further comprises:
a first steering handle extending from the first side edge above the first substantially horizontal portion; and
a second steering handle extending from the second side edge above the first substantially horizontal portion.

14. The steerable sledding system of claim 12, wherein the platform structure further comprises:
a middle portion that forms the second front edge and a second rear edge of the platform structure, wherein the middle portion forms the second opening proximate the second front edge; and
a second curved sidewalls that extend upward from the middle portion to form a third side edge of the platform structure, and
a third curved sidewall that extends upward from the middle portion to form a fourth side edge of the platform structure, wherein the third side edge and the fourth side edge are disposed above the middle portion.

15. The steerable sledding system of claim 11 further comprising:
a first set of runners integral to a first bottom surface of the steering structure; and
a second set of runners integral to a second bottom surface of the platform structure.

16. The steerable sledding system of claim 11 further comprising:
a first set of runners removably coupled to a first bottom surface of the steering structure; and
a second set of runners removably coupled to a second bottom surface of the platform structure.

17. A steerable sledding system comprising:
a steering structure configured to enable a user to steer the steerable sledding system, wherein the steering structure forms a first opening proximate a first rear edge of the steering structure, and wherein the steering structure has a first substantially uniform thickness;
a first handle extending from the steering structure;
a second handle extending from the steering structure, wherein the first handle and the second handle are integral to the steering structure;
a platform structure configured to support the user, wherein the platform structure forms a second opening proximate a second front edge of the platform structure, wherein the platform structure has a second substantially uniform thickness; and
a pivoting device configured to connect the steering structure and the platform structure via the first opening and the second opening to enable the steering structure and the platform structure to pivot relative to each other.

18. The steerable sledding system of claim 17, wherein the steering structure comprises:
a first substantially horizontal portion that forms the first rear edge of the steering structure, wherein the first substantially horizontal portion forms the first opening proximate the first rear edge; and
first curved sidewalls that extend upward from the first substantially horizontal portion to form a front edge, a first side edge, and a second side edge of the steering structure, wherein the front edge, the first side edge, and the second side edge are disposed above the first substantially horizontal portion, wherein the first curved sidewalls and the first substantially horizontal portion have the first substantially uniform thickness.

19. The steerable sledding system of claim 17, wherein the platform structure comprises:
a middle portion that forms the second front edge and a second rear edge of the platform structure, wherein the middle portion forms the second opening proximate the second front edge; and
second curved sidewalls that extend upward from the middle portion to form a third side edge of the platform structure; and
third curved sidewalls that extend upward from the middle portion to form a fourth side edge of the platform structure, wherein the third side edge and the fourth side edge are disposed above the middle portion.

20. The steerable sledding system of claim 19, wherein the first substantially uniform thickness is substantially same as second substantially uniform thickness.
